(19) United States
(12) Patent Application Publication
(10) Pub. No.: US 2019/0045775 A1
(43) Pub. Date: Feb. 14, 2019

(54) Tree stand safety attachment

(71) Applicants: Dalton Brumbaugh, Dublin, OH (US); Joe Brumbaugh, Dublin, OH (US)

(72) Inventors: Dalton Brumbaugh, Dublin, OH (US); Joe Brumbaugh, Dublin, OH (US)

(21) Appl. No.: 15/675,026

(22) Filed: Aug. 11, 2017

(51) Int. Cl. A01M 31/02; F41A 23/18; F16M 13/02

(52) U.S. Cl. CPC A01M 31/02; F16B 7/04; F16M 13/02; F41A 23/18

(57) ABSTRACT

The current invention is a tree stand attachment. It has a sideways “H” styled base with the legs of the base slightly bent downward as to fit the contour of the tree. The matching ends of the base are connected with a strap, one for the lower legs and one for the upper legs. The straps would wrap around the tree to hold the attachment to the tree. Extending perpendicular from the top of the base is the support bar. The support bar has an extension that can be used to extend the support bar. There is a support bar that extend at a 45 degree angle from the support bar to the base. This provides addition required support for the attachment so that the support bar is properly anchored.

### CROSS-REFERENCES TO RELATED APPLICATIONS (IF ANY)

None.

### BACKGROUND

### 1. Field of the Invention

This invention relates to a Tree stand safety attachment for hunters.

### 2. Description of Prior Art

Tree stands or deer stands are open or enclosed platforms used by hunters. The platforms are secured to trees in order to elevate the hunter and give him or her a better vantage point. It can be dangerous for hunters to set up and to ascend to their tree stand especially if it is not a permanent tree stand.

There is still room for improvement in the art.

### SUMMARY OF THE INVENTION

The current invention is a tree stand safety attachment for hunters. It provides a quiet and safe way for a hunter to hang their gear.

The attachment is an efficient way to attach a ‘hang-on’ stand to a tree. It is design so it can be done easily with one hand. The attachment allows hunters to hoist their stand and equipment right up to them while it holds it in place for the hunter to easily secure a stand to a tree. It is designed to be portable and easily slide into a backpack.

The attachment will have a sideways “H” styled base with the legs of the base slightly bent downward as to fit the contour of the tree. The matching ends of the base are connected with a strap, one for the lower legs and one for the upper legs. The straps would wrap around the tree to hold the attachment to the tree. Extending perpendicular from the top of the base is the support bar. The support bar has an extension that can be used to extend the support bar. There is a bracing bar that extend at a 45 degree angle from the support bar to the base. This provides addition required support for the attachment so that the support bar is properly anchored.

The support bar extension has a hook on the end that can be used to hold things such as a bow.

The tree stand would be placed on the top of the support bar.

The attachment would have a pulley with ratchet straps, and at least 40 feet of strap that will feed through a cinch mechanism. The end of the strap should have a sturdy clip for attaching to the stand. The strap and pulley mechanism will allow a user to pull equipment and gear up to the attachment.

### BRIEF DESCRIPTION OF THE DRAWINGS

Without restricting the full scope of this invention, the preferred form of this invention is illustrated in the following drawings:

FIG. 1 shows the tree stand safety attachment;

FIG. 2 is another view of the attachment; and

FIG. 3 shows a closer view of the hook and the pulley; and

FIG. 4 shows a tree stand on the attachment.

### DESCRIPTION OF THE PREFERRED EMBODIMENT

There are a number of significant design features and improvements incorporated within the invention.

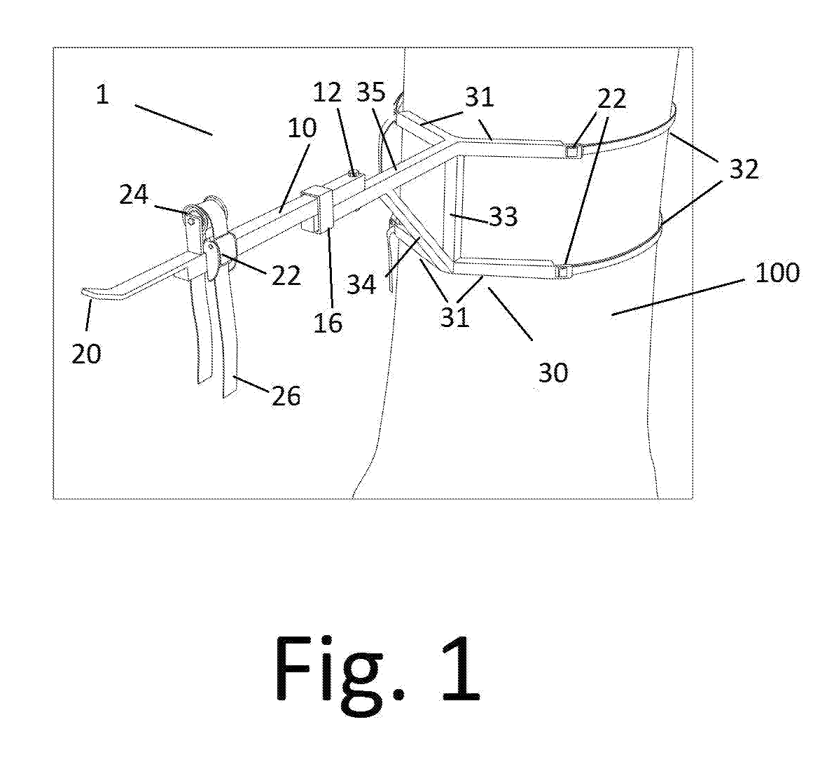

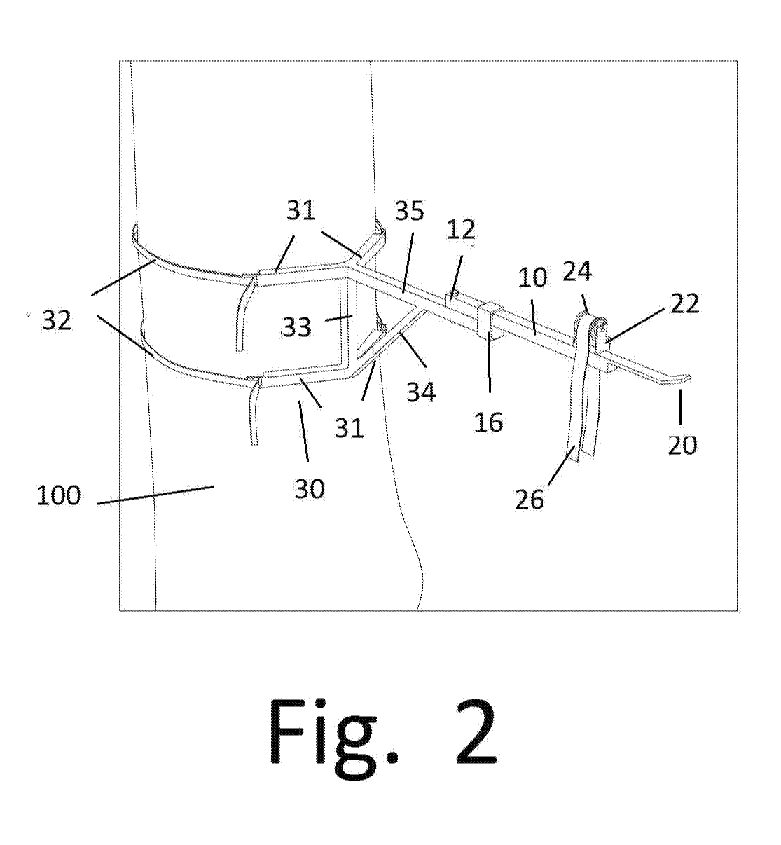

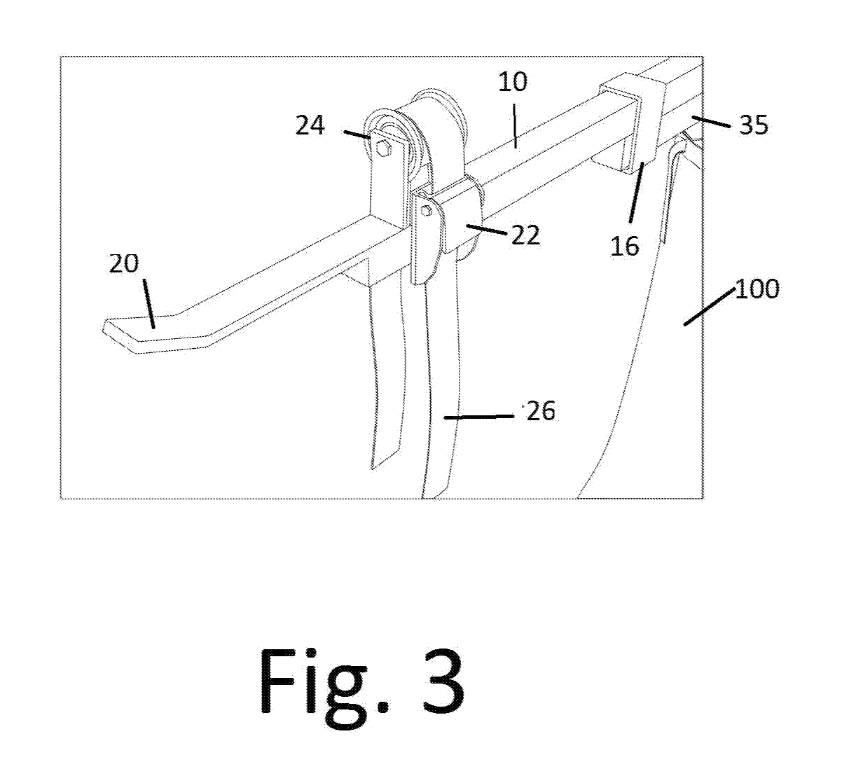

As shown in FIGS. 1 through 4, the current invention is a tree stand safety attachment 1 for hunters. It provides a quiet and safe way for a hunter to hang their gear.

The attachment 1 is an efficient way to attach a ‘hang-on’ stand to a tree 100. It is design so it can be done easily with one hand. The attachment 1 allows hunters to hoist their stand and equipment right up to them while it holds it in place for the hunter to easily secure a stand to a tree. It is designed to be portable and easily slide into a backpack.

The attachment 1 will have a sideways “H” shaped styled base 30 with the legs 31 of the base 30 slightly bent as to fit the contour of the tree 100 with a bar 33 between the legs. The matching ends of the base 30 are connected with a strap 32, one strap 32 for the lower legs and one for the upper legs. The straps 32 are secured to one of the legs would wrap around the tree 100 to hold the attachment to the tree 100 and be secured with a cinch mechanism 22. The straps 32 are pulled tight and the cinch mechanism 22 is closed to securely lock the straps 32.

Extending perpendicular from the top center of the base 30 and away from the tree 100 is the support bar 35. The support bar 35 has an extension 10 that can be used to extend the support bar 35. The extension 10 has a hook 20 at the end and is secured in the extended position by a bolt 12. There is a square bracket 16 that holds the support bar 35 and the extension 10 together. The extension 10 can slid back and forth to be extended or shortened. The extension 10 is slid back against the base 30 when stored.

There is a brace bar 34 that extend at a 45 degree angle from the support bar 35 to the base 30. This provides addition required support for the attachment 1 so that the support bar 35 is properly anchored and does not suffer any structural issues

The support bar extension has a hook 20 on the end that can be used to hold things such as a bow.

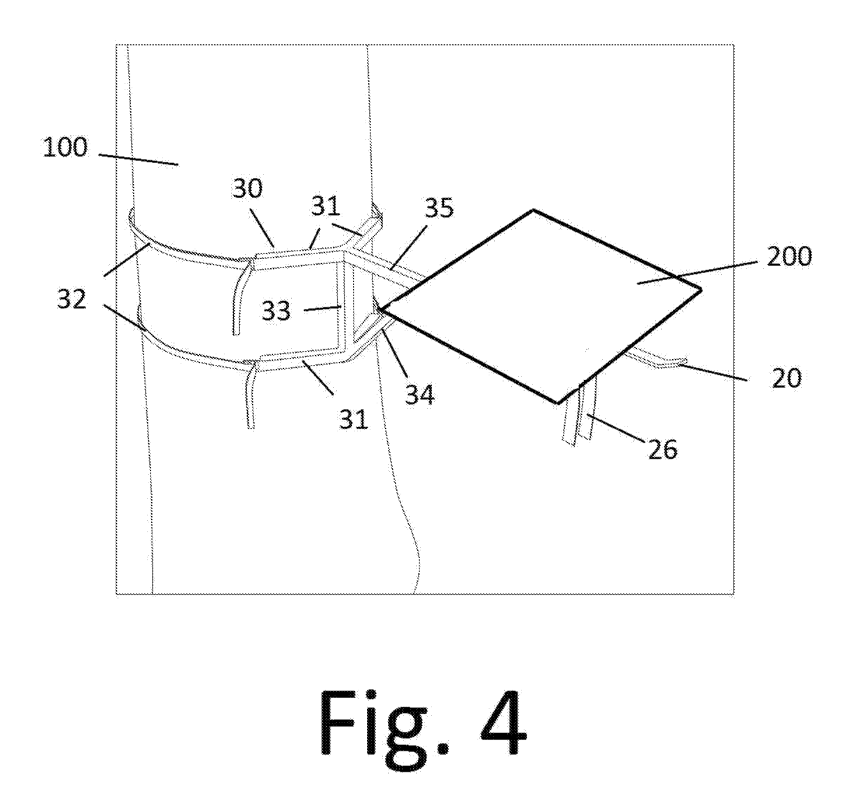

The tree stand 200 could be placed on the top of the support bar 35 as shown in FIG. 4.

The attachment would have a pulley 24 with ratchet straps 26, and at least 40 feet of strap that will feed through a cinch mechanism 22. The end of the strap 26 should have a sturdy clip for attaching to the stand. The strap 26 and pulley 24 mechanism will allow a user to pull equipment and gear up to the attachment 1.

The pulley system 24 is on top of the support bar 25 facing the same way as the cinch mechanism 22 is facing so that the strap 26 can be ran up and over the top of the attachment 1. The pulley 24 needs to be inline and right next to the cinch mechanism 22 so that it will function properly.

The base 30 and bars would be made of a strong like weight metal like aluminum.

### Advantages

The current invention has the advantage of quietly and safely hanging a stand and gear. The attachment is a safe and efficient way to attach a ‘hang on’ stand to a tree. The attachment eliminates the need of climbing up and down a tree more than once. The Branch is the only hunting accessory needed for hanging a stand, storing gear, and safely getting into the tree. Once secured, a user can safely hoist their equipment. It eliminates the need of climbing up and down the tree more than once.

Although the present invention has been described in considerable detail with reference to certain preferred versions thereof, other versions are possible such as different tension means, bobber shapes and sizes and different colored lights. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1-20. (canceled)

1. A device comprising:
A base with a plurality of legs where the base is in a sideways “H” shape where the legs are secured with a cinch mechanism with a plurality of straps attached between pairs of said legs where the straps goes around a tree, said straps are pulled tight and the cinch mechanism is closed to securely lock the straps and hold the base up with a support beam that extends perpendicular from said base and a brace bar that extend at a 45 degree angle from the support beam to the base having a pulley with ratchet straps that will feed through a cinch mechanism and where the pulley is attached to the support beam.

2. A device according to claim 1 comprising:
Where the support beam has an extension.

3. (canceled)

4. A device according to claim 1 comprising:

5. A device according to claim 1 comprising:
Where a tree stand is secured to the support beam.

6. A device according to claim 1 comprising:
Having a hook at the end of the support beam.

7. A device according to claim 1 comprising:
Having a support bar that extends from the base to the support beam.

8. (canceled)
